(19) United States
(12) Patent Application Publication
(10) Pub. No.: US 2005/0234961 A1
(43) Pub. Date: Oct. 20, 2005

(54) Systems and Methods for providing a proxy for a shared file system

(75) Inventors: Don Edvalson, Gainesville, FL (US); Pawel Malinowski, Hayward, CA (US); Mark Johnston, San Jose, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Pinnacle Systems, Inc.

(21) Appl. No.: 10/825,679

(22) Filed: Apr. 16, 2004

(51) Int. Cl. G06F 17/30

(52) U.S. Cl. 707/102; 707/200

(57) ABSTRACT

Methods and systems are provided for representing a shared file system using a proxy file system. Methods and systems may manage a plurality of proxy files, which are associated with counterpart data files in a shared storage. The proxy files may include information for accessing the counterpart data files. Methods and systems may provide clients with access to the data files in the shared storage via the proxy files.

### TECHNICAL FIELD

The present invention generally relates to data processing systems and, more particularly, to systems and methods for providing a proxy for a shared file system. In one example, a non-sharable file system may serve as a proxy for a larger sharable file system.

### BACKGROUND

Information management is critical in the modern business landscape. In particular, the ability to effectively store and access information is essential to the survival of any business. The amount of data that businesses must manage has increased drastically with the advent of the Internet, electronic commerce transactions, and the automation of traditional business tasks. Business application and intelligence systems, customer relationship management applications, and enterprise resource planning systems further add to the growing amount of data requiring robust and efficient management. Information management, especially storage, is therefore an imperative aspect of business planning.

To cope with an increasing amount of business-related information, businesses often implement Storage Area Networks (SANs) in their suite of computing resources. A SAN is a dedicated high-speed network interconnecting various data storage systems and servers. SANs may be clustered with mainframes and other resources and/or may leverage network technologies (e.g., ATM, SONET, etc.) to provide storage capabilities. Typical SANs may provide features such as disk mirroring and restoration, as well as data archival, retrieval, migration and sharing.

One shortcoming of SANs is their inability to behave like a local file system, such as the New Technology File System (NTFS) used by the Windows NT operating system, or the High Performance File System (HPFS) used by OS/2. This weakness is largely due the amount of code involved and the number of test cases that would need to run to emulate such a file system. The code often becomes unmanageable and slow when an attempt to emulate a real file system with a SAN is made. In addition, advanced file system features (e.g., security, locking, sharing, change notification, etc.) are seldom implemented properly in SANs.

### SUMMARY

Methods, systems, and articles of manufacture consistent with aspects and principles of the present invention may obviate one or more of the above and/or other problems by providing a proxy file system for a larger shared file system. In certain implementations, methods and systems consistent with the present invention may leverage a local non-sharable file system in order to represent a larger sharable file system. The present invention may combine the power, speed, and file sharing capabilities of SANs with the flexibility and code compatibility of local file systems.

Methods and systems consistent with the present invention may manage a plurality of proxy files, which are associated with counterpart data files in a shared storage. The proxy files may include information for accessing the counterpart data files. Methods and systems may control access, by clients, to the counterpart data files in the shared storage via the proxy files.

Methods and systems consistent with the present invention may recognize an attempt by a client to access a data file in a shared storage. Methods and systems may access a proxy file corresponding to the data file in response to the access attempt. Methods and systems may retrieve from the proxy file information for accessing the data file from the shared storage and provide the client with access to the data file in the shared storage using the retrieved access information.

The foregoing background and summary are not intended to be comprehensive, but instead serve to help artisans of ordinary skill understand the following implementations consistent with the invention set forth in the appended claims. In addition, the foregoing background and summary are not intended to provide any independent limitations on the claimed invention.

### BRIEF DESCRIPTION OF THE DRAWINGS

The accompanying drawings show features of implementations consistent with the present invention and, together with the corresponding written description, help explain principles associated with the invention. In the drawings:

FIG. 1 is a block diagram of an architecture illustrating features and aspects consistent with the present invention;

FIG. 2 is an exemplary block diagram of a controller consistent with the present invention;

FIG. 3 is an exemplary block diagram of a client consistent with the present invention;

FIG. 4 is a flowchart depicting a configuration method consistent with the present invention;

FIG. 5 is a flowchart depicting a file access method consistent with the present invention; and

FIG. 6 is a flowchart depicting a method for reading from and writing to files consistent with the present invention.

### DETAILED DESCRIPTION

The following description refers to the accompanying drawings, in which, in the absence of a contrary representation, the same numbers in different drawings represent similar elements. The implementations set forth in the following description do not represent all implementations consistent with the claimed invention. Instead, they are merely some examples of systems and methods consistent with the invention. Other implementations may be used and structural and procedural changes may be made without departing from the scope of present invention.

Consistent with aspects of the present invention, methods and systems may provide a proxy file system. The proxy file system may be non-sharable and serve as a basis for a larger high performance sharable file system. Methods and systems consistent with the invention may represent (i.e., provide a proxy for) a shared file system by leveraging a local disk running a file system such as NTFS. In certain configurations, the proxy file system may have a 1:1 correspondence with the shared file system. That is, every file on the shared file system may have a corresponding smaller proxy file on the proxy file system. In certain configurations, each proxy file on the local disk may contain information necessary to access its counterpart file on the shared file system. In operation, when a user attempts to open a file on the shared file system, a corresponding file on the proxy file system may open instead. Information indicating how to read the shared file may be read from the proxy file and used to read the data from the shared file system as requested by the user.

The foregoing discussion is intended to introduce and provide initial clarity for some of the aspects associated with the present invention. Further details of these embodiments as well as additional aspects and embodiments of the present invention will be described below.

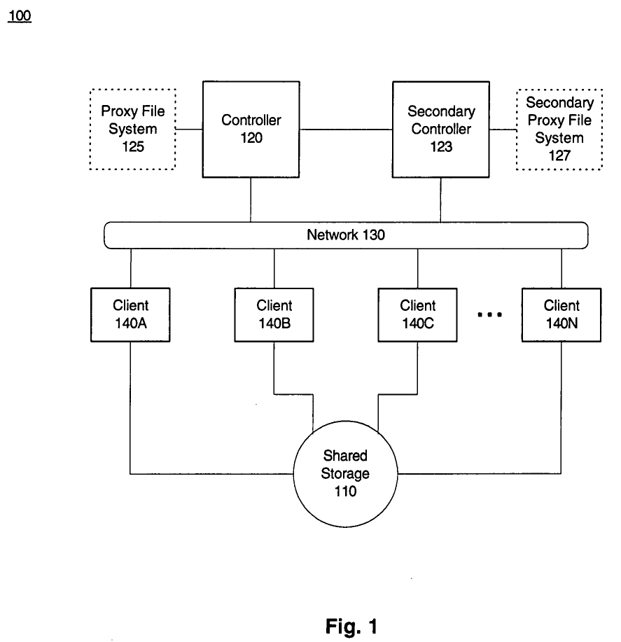

FIG. 1 is a block diagram of an architecture 100, compatible with features and aspects consistent with the present invention. Architecture 100 may include a shared storage 110, a controller 120, a secondary controller 123, a proxy file system 125, a secondary proxy file system 127, a network 130, and clients 140A-140N. The number of components in architecture 100 is not limited to what is shown and other variations in the number of arrangements of components are possible, consistent with embodiments of the invention.

Shared storage 110 may represent any storage resource from which a plurality of users can store, access, and manage information. Shared storage 110 may be implemented with a variety of components or subsystems including, for example, magnetic and optical storage elements, organic storage elements, audio disks, and video disks. Shared storage 110 may include one or more elements of a SAN. Shared storage 110 may include one or more structured data archives distributed among one or more network-based data processing systems. Shared storage 110 may include one or more relational databases, distributed databases, object-oriented programming databases, and/or any other mechanism, device, or structure for managing, accessing, and updating an aggregation of data. Shared storage 110 may store, for example, numeric information, textual information, audible information, graphical information, etc.

Shared storage 110 may also include and/or leverage a shared file system (not illustrated in FIG. 1) for managing information stored on shared storage 110. The shared file system may enable clients 140A-N to simultaneously access files in shared storage 110. The shared file system may enable clients 140A-N to simultaneously access files through different operating systems. The shared file system may also provide a global or central namespace, which allows clients 140A-140N to locate files in shared storage 110. In certain configurations, such a namespace may include element and attribute types and/or identifiers.

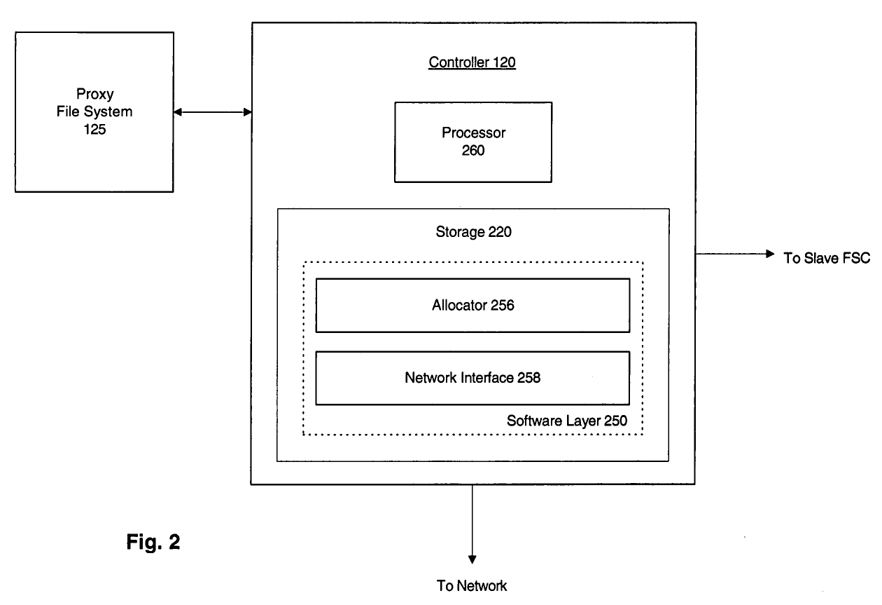

Controller 120 may represent one or more systems, modules, and/or devices for controlling data on shared storage 110. Controller 120 may control client access to shared storage 110. In certain configurations, controller 120 may allocate, de-allocate, and manage space on shared storage 110. Controller 120 may also track data (e.g., files) on shared storage 140 as well as attributes, permissions, and other system information associated with data located in shared storage 110. Consistent with embodiments of the present invention, controller 120 may include one or more hardware, software, and/or firmware components that enable it to perform its respective functions. In one example, controller 120 may be implemented by way of data processing system, such as server computer (e.g., a Windows XP server). An exemplary implementation of controller 120 is detailed below in connection with FIG. 2.

Proxy file system 125 may be implemented by one or more hardware, software, and or firmware components and may be leveraged by controller 120 to provide various features to architecture 100. Proxy file system 125 may include any appropriate mechanism and/or module for storing and retrieving information (e.g., files). Proxy file system 125 may represent file systems such as NTFS, FAT, VFAT, HPFS, ReiserFS, XFS, JFS, and/or UFS. Proxy file system 125 may be smaller in size than shared storage 110. For example, shared storage 110 may be 500,000 times larger than proxy file system 125. In one implementation, proxy file system 125 may be a non-sharable file system running on a disk coupled to controller 120. Although FIG. 1 illustrates proxy file system 125 as external to controller 120, proxy file system 125 may reside on a disk located within controller 120.

Proxy file system 125 may include or leverage one or more processes and directory schemes for tracking information. For example, proxy file system 125 may leverage one or more tree structures (e.g., a B-tree, a binary tree, a splay tree, a quad tree, an M-tree, an X-tree, etc.) to track files and file clusters. Proxy file system 125 may also specify file paths associated with such structures. In addition, proxy file system 125 may specify naming conventions for files.

Proxy file system 125 may have a 1:1 correspondence with shared storage 110. That is, every file on shared storage 110 may have a corresponding proxy file managed by proxy file system 125. The proxy files may be stored on a local disk coupled to controller 120. The proxy files may also be included in proxy file system 125. Each proxy file may be smaller in size than its corresponding file in shared storage 110. In one example, each proxy file may have the same name as its counterpart file in shared storage 110.

In certain configurations, each proxy file may contain information necessary to access (e.g., instructions on how to access) its counterpart file on the shared file system. Proxy files managed by proxy file system 125 may, for example, include one or more lists of allocation units (AUs) for corresponding files on shared storage 110. In certain configurations, proxy files may not include the data in the corresponding file in shared storage. As used herein, an “AU” refers to a portion or block of storage space. An “AU” may indicate where on shared storage 110 a particular file resides. In certain implementations of the present invention, for every 1-4 Mbytes in a shared storage 110 file, there may be 8 bytes in the corresponding proxy file. Assuming, for example, 4 Megabyte AUs on proxy file system 125, a 1 Gigabyte proxy file system could represent a 500 Terabyte shared storage (e.g., SAN) with more than 250,000 files. In this fashion, proxy file system 125 may serve as a file system “amplifier.”

In certain implementations of the invention, proxy files may include attribute information associated with shared files. Such attribute information may include information that may be valuable/useful to applications using the shared files. The attribute information may include, for example, bit rates and data types. A given proxy file may also include one or more associations with or links to other proxy files. In operation, when a proxy file containing such an association is accessed, information included in an associated proxy file may be retrieved and leveraged.

Proxy file system 125 may include one or more modules, processes, applications, and/or devices for providing, for example, security, locking, sharing, and change notification functions for architecture 100. Consistent with certain embodiments of the present invention, proxy file system 125 may be configured to dynamically notify controller 120 on a real time basis regarding the appearance and disappearance of various volumes in shared storage 110. Security functions may include DOS-based write protect features, access control lists (e.g., for specifying which clients and/or users can access certain information), and other control mechanisms and schemes. Proxy file system 125 may also perform various user validation and authentication functions. Proxy file system 125 may provide security features on a file-by-file basis, and it may provide security on removable and/or fixed disks.

Locking functions may enable applications to specify that one or more portions of a given file be locked, thereby preventing other processes/applications from accessing that portion. Facilitating change notifications may include notifying application of various changes, such as file deletions and creations. Facilitating change notifications may involve enabling an application to register with proxy file system 125 in a particular file, directory, or directory tree. When changes within that tree (e.g., file creation, deletion, etc.) occur, the application may be notified.

Secondary controller 123 may be similar in structure to controller 120. Secondary controller 123 may be coupled to a secondary proxy file system 127, which may be similar in structure and function as proxy file system 125. In certain implementations, controller 120 may be configured as a primary controller and secondary controller 123 may serve as a backup for controller 120. Secondary controller 123 may mirror the current primary controller (e.g., controller 120) and may replace the primary controller in the event it is disabled. The terms “primary” and “secondary” may refer to modes of operation. In the “primary” mode of operation, a controller may perform, for example, allocation functions and proxy file modifications. Controller 120 and secondary controller 123 may be similar in structure, and each of these controllers may be capable of operating as the current “primary” controller at any given time. Accordingly, if the current primary controller (i.e., controller 120) fails or is disabled, secondary controller 123 may assume a primary mode of operation and serve as the current “primary” controller. Secondary controller 123 may replace a disabled primary controller automatically or in response to received instructions. In certain implementations of the invention, clients 140A-N may be aware of the primary and secondary controllers and may recognize current primary controller changes. For example, clients 140A-N may recognize when secondary controller 123 replaces controller 120 as the current primary controller.

Although a single secondary controller 123, with a corresponding secondary proxy file system 127, is depicted in FIG. 1, any number of geographically dispersed secondary controllers 123 and corresponding secondary proxy file systems 127 may be implemented in architecture 100. Moreover, although depicted in architecture 100, secondary controller 123 and secondary proxy file system 127 are optional and may not be present in certain implementations of the present invention.

Controller 120, as well as secondary controller 123, may be coupled to network 130. Network 130 may be the Internet, a virtual private network, a local area network, a wide area network, a broadband digital network or any other appropriate structure for enabling communication between two or more nodes or locations. Network 130 may include a shared, public, or private data network and encompass a wide area or local area. Network 130 may include one or more wired and/or wireless connections. Network 130 may employ communication protocols such as User Datagram Protocol (UDP), Transmission Control and Internet Protocol (TCP/IP), Asynchronous Transfer Mode (ATM), SONET, Ethernet, or any other compilation of procedures for controlling communications among network locations. Further, in certain embodiments, network 130 may leverage voice-over Internet Protocol (“VoIP” ) technology. In certain configurations, network 130 may be a “fault tolerant network.” As such, network 130 may be configured to facilitate uninterrupted data exchange even when a fault (e.g., line damage) occurs.

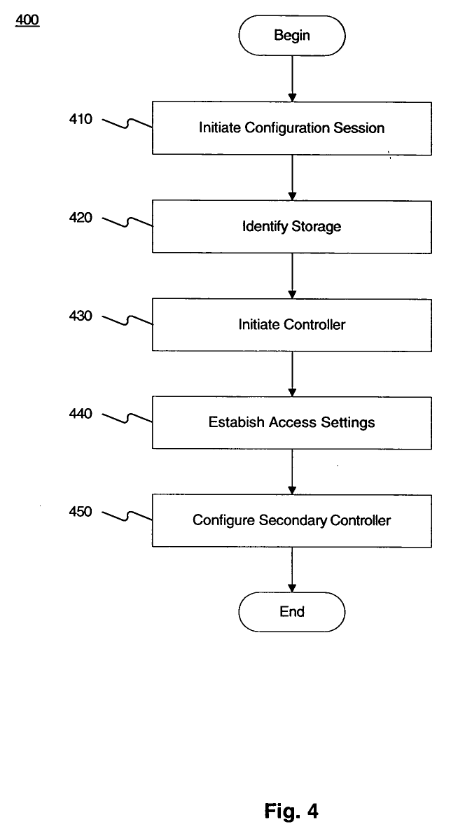

Architecture 100 may include one or more client 140A-140N, which may be coupled to or included in network 130. Clients 140A-N may represent one or more devices used by one or more users to access network 130 and shared storage 110. It should also be understood that any number of geographically-dispersed clients 140 may be included in architecture 100. In one configuration, each of clients 140A-N may include a general purpose computer, a personal computer (e.g., a desktop), or a workstation. Clients 140A-N may also include mobile computing devices (e.g., laptops, PDAs, a Blackberry™, an Ergo Audrey™, etc.), mobile communications devices (e.g., cell phones), or other structures that enable users to remotely access information. In certain configurations, clients 140A-N could include kiosks or “dumb” terminals coupled to one or more central data processing systems. Those skilled in the art will realize that each of clients 140A-N may be different in structure and capability. For example, client 140A could be a desktop computer while client 140B could be a mobile computing device. One exemplary configuration of a client 140 is detailed below in connection with FIG. 4.

Various components within architecture 100 may be operatively connected to network 130 by communication devices and software known in the art, such as those commonly employed by Internet Service Providers (ISPs) or as part of an Internet gateway. Such components may be assigned network identifiers (ID). As used herein, the term “ID” refers to any symbol, value, tag, or identifier used for addressing, identifying, relating, or referencing a particular element. Network lDs, for example, may include IP addresses.

Client 140A-N may be operatively connected to shared storage 110 via one or more communication protocols and devices. In one exemplary implementation of the present invention, clients 140A-N may be coupled to shared storage 110 by way of optical fiber, Fibre Channel, SCSI (Small Computer System Interface), and/or iSCSI (Internet SCSI) technology. Clients 140A-N may, for example, be coupled to shared storage 110 using ESCON (Enterprise Systems Connection) technology, Fibre Channel over IP (FCIP), and/or the Internet Fibre Channel Protocol (iFCP). Further, various switches, routers, and other communications elements may be leveraged to enable clients 140A-N to communicate with shared storage 110. In certain configurations, network 130 may also leverage such optical fiber, Fibre Channel, SCSI, and/or iSCSI technology and devices.

FIG. 2 is a block diagram illustrating one exemplary configuration of controller 120 consistent with the present invention. As illustrated in FIG. 2, controller 120 may comprise, storage 220, a software layer 250, and a processor 260. A system bus (not illustrated) may interconnect such components. Such a system bus may be a bidirectional system bus. For example, it could contain separate address lines and data lines. Alternatively, the data and address lines may be multiplexed.

Storage 220 may provide mass storage and/or cache memory for controller 120. In addition, storage 220 may include elements for providing a primary memory for processor 260, such as for program code. Storage 220 may be implemented with a variety of components or subsystems including, for example, a hard drive, an optical drive, CD ROM drive, DVD drive, a general-purpose storage device, a removable storage device, and/or other devices capable of storing information. Storage 220 may include a random access memory, a read-only memory, magnetic and optical storage elements, organic storage elements, audio disks, and video disks. Although storage 220 is shown within controller 120, storage 220 may be implemented external to controller 120. Further, although a single storage module is shown, any number of modules may be included in controller 120, and each may be configured for performing distinct functions.

Storage 220 may include program code for various applications, an operating system, an application-programming interface, application routines, and/or other executable instructions. Storage 220 may also include program code and information for communications, kernel and device drivers, and configuration information. Although illustrated external to controller 120, proxy file system 125 may be located in storage 220 in certain implementations of the present invention. In addition, proxy files managed by proxy file system 125 may be located in storage 220.

Software layer 250 may include an allocator component 256 and a network interface component 258 and may be implemented in storage 220 of controller 120. Allocator 256 may include executable program code for allocating and de-allocating AUs and tracking files stored in shared storage 110. Allocator 256 may maintain a list of AU numbers or other identifiers and provide them to clients 140A-140N on demand. Allocator 256 may de-allocate AUs in response to file deletions. In one configuration, allocator 256 may include and/or leverage a RAM-based allocation scheme in which AUs to be allocated are derived from a linked list in storage 220.

Network interface 258 may include executable program code for facilitating information exchange between controller 120 and network 130. Network interface 258 may leverage hardware, software, and/or firmware elements. In one example, network interface 258 may interact with one or more network cards and/or ports.

In certain configurations, software layer 250 may include or leverage a hardware interface component. Such a hardware interface component may include boot executable software and/or driver software that drives one or more components coupled to controller 120.

Processor 260 may be operatively configured to execute instructions. Processor 260 may be configured for routing information among components and devices and for executing instructions from one or more memories. Although FIG. 2 illustrates a single processor, controller 120 may include a plurality of general purpose processors and/or special purpose processors (e.g., ASICS). Processor 120 may also include, for example, one or more of the following: a co-processor, a memory, registers, and other processing devices and systems as appropriate. Processor 120 may be implemented, for example, using a Pentium™ processor provided from Intel Corporation.

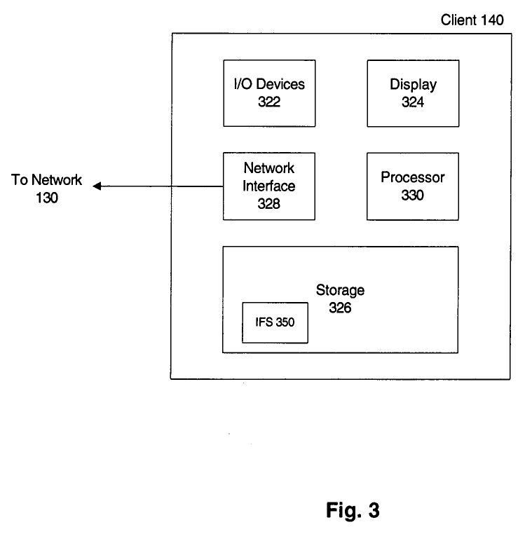

FIG. 3 is a block diagram of an exemplary client 140. Client 140 may comprise I/O devices 322, a display 324, storage 326, a network interface 328, and a processor 330. A system bus (not illustrated) may interconnect such components, as discussed above in connection with controller 120.

Client 140 may receive input via one or more input/output (I/O) devices 322. I/O devices 322 may include components such as keyboard, a mouse, a pointing device, and/or a touch screen or information-capture devices, such as audio- or video-capture devices. For example, I/O devices 322 may include a microphone and be coupled to voice recognition software for recognizing and parsing utterances. I/O devices 322 may additionally or alternatively include one or more data reading devices and/or an input ports.

Client 140 may present information and interfaces (e.g., GUIs) via display 324. Display 324 may be configured to display text, images, or any other type of information. In certain configurations, display 324 may display information by way of a cathode ray tube, liquid crystal, light-emitting diode, gas plasma, or other type of display mechanism. Display 324 may additionally or alternatively be configured to audibly present information. For example, display 324 could include a speaker or some other audio output device, for providing audible sounds to a user. In fact, display 324 may include or be coupled to audio software configured to generate synthesized or pre-recorded human utterances. In this way, display 324 may be used in conjunction with I/O devices 322 for facilitating user interaction with client 140.

Storage 326 may provide mass storage and/or cache memory for client 140. Storage 326 may be implemented with a variety of components or subsystems including those described above in connection with storage 220. In certain configurations, storage 326 may include or leverage one or more programmable, erasable and/or re-useable storage components, such as EPROM (erasable programmable read-only memory) and EEPROM (erasable programmable read-only memory). Storage 326 may also include or leverage constantly-powered nonvolatile memory operable to be erased and programmed in blocks, such as flash memory (i.e., flash RAM). Although storage 326 is shown within client 140, storage 326 may be implemented external to client 140. Further, although a single storage module is shown, any number of modules may be included in client 140, and each may be configured for performing distinct functions.

Storage 326 may include program code for various client applications, an operating system, an application-programming interface, application routines, and/or other executable instructions. Storage 326 may also include program code and information for communications, kernel and device drivers, and configuration information. Storage 326 may include program code and/or information (e.g., program code 350) used by client 140 to communicate with shared storage 110, controller 120, and secondary controller 123. In one example, storage 326 may include a Windows Installable File System (IFS) as program code 350, which may be installed in the operating system kernel space and invisible to applications running on client 140. Program code 350 may enable volumes of shared storage 110 to appear as part of a given client's disk space. For example, a volume might appear as a drive letter such a P: or a directory mount such as C:\videoclips.

Storage 326 may also include program code for recognizing system configurations and changes. Such program code may, for example, provide the client with an awareness of the current primary controller (and secondary controller(s)) and ensure that client requests are routed properly and answered. The program code may also recognize and react to primary controller changes. For example, the code may be aware of controller 120 and secondary controller 123 and may detect when secondary controller 123 replaces controller 120 as the current primary controller.

As explained above, proxy file system 125 may dynamically notify controller 120 regarding the appearance and disappearance of various volumes in shared storage 110. Consistent with certain embodiments of the present invention, however, program code 350 may be configured to perform such functionality, either in conjunction with proxy file system 125 or unilaterally.

Storage 326 may also provide a primary memory for processor 330, such as for program code. Processor 330 may be similar to processor 260 described above. When client 140 executes applications and/or instructions installed in storage 326, processor 330 may download at least a portion of program code from storage 326 into a primary processor memory (not shown). As processor 330 executes the program code, processor 330 may also retrieve additional portions of program code from storage 326.

Network interface 328 may be any appropriate mechanism and/or module for facilitating communication with network 130, shared storage 110, and/or any other network, such as an attached Ethernet LAN, serial line, etc. Network interface 328 may be configured for sending information to and receiving information from network 130. Network interface 328 may include or leverage one or more network cards and data ports.

The configuration of controller 120 and clients 140A-N are exemplary only. In certain configuration, clients 140A-N may include components similar to those included in controller 120. Clients 140A-N may, however, be structurally different from controller 120 and may have varying or additional components. Likewise, controller 120 may include certain components illustrated in FIG. 3 but not shown in FIG. 2. In addition, each of clients 140A-N may be different in structure.

FIG. 4 is a flowchart depicting an exemplary system configuration process 400 consistent with principles of the present invention. Process 400 may begin by implementing architecture 100 in a given environment (e.g., configuring client devices, installing software, etc.) and initiating a configuration session (stage 410). In certain embodiments of the present invention, a systems administrator or other designated user may initiate a configuration session with controller 120 using a configuration application, which may be a web-based application.

Once a configuration session is established, active storage elements may be identified (stage 420). In one configuration, controller 120 may generate and transmit a query to one or more of clients 140A-N to determine the active storage elements (e.g., disks attached to a Fibre Channel). In response to this query, the receiving client 140 may return a message to controller 120 indicating the active storage elements. Consistent with principles of the present invention, controller 120 may identify storage used by the entire network by interrogating a single client. While controller 120 may identify storage during a configuration session, controller 120 may also identify storage subsequent to initial configuration (e.g., by sending queries to various clients at predetermined intervals). As described above, controller 120 may also be dynamically updated regarding the addition and removal of storage elements by proxy file system 125 and/or program code 350 (e.g., IFS) in a given client 140.

Once the active storage elements are identified (stage 420), controller 120 may be initiated (stage 430). Initiating controller 120 may include initiating allocator 256 and proxy file system 125, creating volumes corresponding to the identified storage, designating AUs, etc.

The configuration process illustrated in FIG. 4 may also include establishing access settings (stage 440). Establishing access settings may include registering client devices and users, generating passwords, providing passwords to clients and users, and/or setting user- and/or device-specific access levels and restrictions (e.g., configuring access control lists in proxy file system 125). For example, establishing access settings may include restricting certain users and/or client devices from accessing certain information in shared storage 110. In addition, process 400 illustrated in FIG. 4 may include installing and configuring one or more secondary controllers 123 (stage 440). This may include specifying rules and settings which control how and when the secondary controller(s) can replace controller 120. As indicated above, secondary controller 123 is optional and may not be included in architecture 100. Accordingly, process 400 may not include stage 440 in certain implementations of the invention.

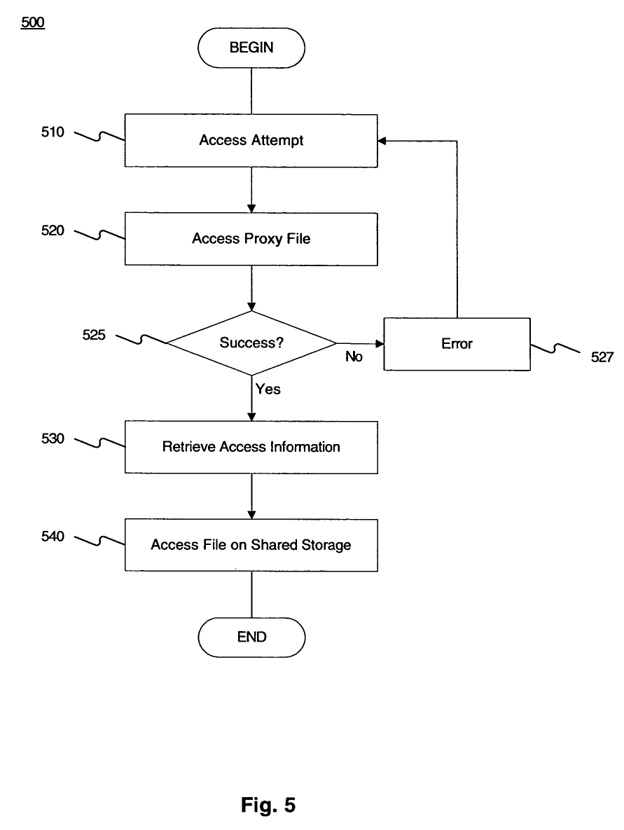

FIG. 5 is a flowchart depicting an exemplary file access method 500 consistent with principles of the present invention. Method 500 may begin when an attempt to access a file (stage 510) occurs. For example, a user associated with client 140A may attempt to open a file on a drive appearing on client 140A. Applications running on a client (e.g., 140A) may also attempt to access a file. In response to an attempt to access a desired file, a proxy file corresponding to the desired file may be identified and accessed from proxy file system 125 (stage 520). Controller 120 may attempt access the proxy file. In certain implementations of the present invention, each proxy file may have the same name as its corresponding file on shared storage 110. In such implementations, a proxy file corresponding to a file on shared storage 110 may be identified by comparing the name of the shared storage file with the names of the proxy files.

If the proxy file is successfully accessed (stage 525—Yes), then access information may be retrieved from the proxy file (stage 530). Such access information may include information regarding how to access (e.g., read) the desired file from shared storage 110 and where the file is located on shared storage 110. Access information may include one or more AUs. In one implementation of the present invention, controller 120 may retrieve access information from proxy files by reading the information from the proxy files. Retrieving access information may include mapping a shared storage handle to a local handle. If the proxy file cannot be accessed (stage 525—No), an error message may be returned to the requesting client (stage 527) and, in certain embodiments, presented to the user. In one configuration, controller 120 (e.g., via proxy file system 125) may track unsuccessful access attempts in one or more activity logs.

Once the access information is retrieved from the proxy file corresponding to the desired file on shared storage 110, the desired file may be accessed from shared storage 110 (stage 540). In one implementation, controller 120 may transmit to the requesting client (e.g., client 140A) information which specifies how to access the desired file (e.g., derived from the access information retrieved from the proxy file), and the requesting client may access the desired file from shared storage 110 using the information received from controller 120.

Although not illustrated in FIG. 5, user authentication and validation processes may be included in the illustrated method. Prior to attempting to access a file (stage 510), a user may login to network 130 and shared storage 110 (e.g., by inputting credentials to a client 140). Users may additionally, or alternatively, enter credentials on a file-by-file basis or other as-needed basis. Users may enter (e.g., in response to a prompt) credentials contemporaneously with attempting to access a file or subsequent to an access attempt (e.g., immediately after an attempt). Users may also be prompted to enter credentials at predetermined time intervals. Credentials may include usernames, passwords, etc. In certain implementations, the user-entered credentials may be routed from the respective client to controller 120 (and, in certain configurations of architecture 100, from controller 120 to secondary controller 123). In addition, or as an alternative, clients 140A-N may automatically route credentials to controller 120. Proxy file system 125 may perform user validation and authentication functions using the entered credentials. In certain configurations of architecture 100, a public key infrastructure (PKI) employing public key cryptography may be leveraged to perform user authentication processes.

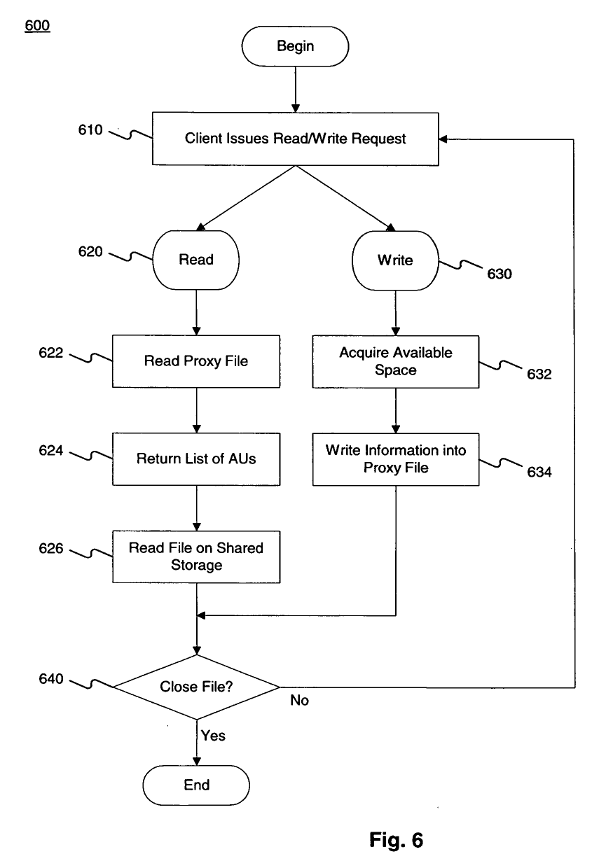

FIG. 6 is a flowchart depicting an exemplary method 600 for reading from and writing to files consistent with principles of the present invention. Method 600 may begin when a requesting client (e.g., client 140A) issues a read and/or write request (stage 610). A client may issue a read or write request in order to read from and/or write to one or more files on shared storage 110 accessed by the client. Clients 140A-140N may issue read/write requests to controller 120 via network 130. Clients may access files on shared storage 110 in accordance with one or more of the processes/events described above in connection with FIG. 5.

If the requesting client issues a request to read from a file on shared storage 110 (620), then a proxy file corresponding to the shared storage file may be identified and read (stage 622). As mentioned above, the proxy file may have the same name as its shared storage counterpart. Controller 120 may read the appropriate proxy file in response to a received read request. Controller 120 may then return to the requesting client a list of AUs from the proxy file (stage 624). After receiving the list of AUs, the requesting client may read information from the corresponding file on shared storage 110 (stage 626) using the AUs.

If the requesting client issues is writing to a data file on shared storage 110 and requests space on the shared storage into which to write (630), then controller 120 may acquire available space on shared storage 110 for the write (stage 632). Acquiring available space may include identifying and/or obtaining/reserving available space. Controller 120 may acquire the space in shared storage via allocator 256 in software layer 250. In one configuration, controller 120 may examine a list of AUs in order to identify available space. In certain configurations, controller 120 may also allocate the acquired available space on shared storage to the data file for the write. Controller 120 may then insert information identifying the acquired space for the write into a proxy file corresponding to the shared storage file (stage 634). In this fashion, the proxy file will be updated to reflect data writes to its counterpart data file in shared storage 110. For example, controller 120 may write AUs associated with the available space into the proxy file. A client may read from and write to files in accordance with the illustrated method until the client closes the files (stage 640).

FIGS. 4-6 are consistent with exemplary implementations of the present invention. Further, the sequence of events described in FIGS. 4-6 are exemplary and not intended to be limiting. Other steps may therefore be used, and even with the methods depicted in FIGS. 4-6, the particular order of events may vary without departing from the scope of the present invention. Moreover, certain steps may not be present and additional steps may be implemented in the methods illustrated in FIGS. 4-6. In addition, it should be understood that the stages of FIGS. 4-6 may be modified with departing from the scope of the present invention.

For purposes of explanation only, certain aspects of the present invention are described herein with reference to the discrete functional elements illustrated in FIGS. 1-3. The functionality of the illustrated elements and modules may, however, overlap and/or may be present in a fewer or greater number of elements and modules. Elements of each system may, depending on the implementation, lack certain illustrated components and/or contain, or be coupled to, additional or varying components not shown. Further, all or part of the functionality of the illustrated elements may co-exist or be distributed among several geographically dispersed locations. Moreover, embodiments, features, aspects and principles of the present invention may be implemented in various environments and are not limited to the illustrated environments and architectures. In addition, the processes disclosed herein are not inherently related to any particular apparatus or system and may be implemented by any suitable combination of components.

The foregoing description of possible implementations consistent with the present invention does not represent a comprehensive list of all such implementations or all variations of the implementations described. The description of only some implementations should not be construed as an intent to exclude other implementations. Artisans will understand how to implement the invention in the appended claims in may other ways, using equivalents and alternatives that do not depart from the scope of the following claims. Moreover, unless indicated to the contrary in the preceding description, none of the components described in the implementations is essential to the invention.

1. A file management system, comprising:
a proxy file system for managing a plurality of proxy files, wherein the plurality of proxy files are associated with counterpart data files in a shared storage and include information for accessing the counterpart data files from the shared storage; and
a controller for controlling access by a plurality of clients to the counterpart data files in the shared storage using the proxy file system.

2. The system of claim 1, wherein the controller is configured to provide the clients with access to the counterpart data files in the shared storage using the access information included in the proxy files.

3. The system of claim 2, wherein the controller is configured to:
recognize attempts by the clients to access the counterpart data files in the shared storage;
retrieve from the proxy files the information for accessing the counterpart data files from the shared storage in response to the access attempts; and
provide the clients with access to the counterpart data files in the shared storage using the access information retrieved from the proxy files.

4. The system of claim 1, wherein the shared storage comprises a port to receive access via a network from the plurality of clients.

5. The system of claim 1, wherein the proxy file system comprises a non-sharable file system running on a local disk coupled to the controller.

6. The system of claim 1, wherein the proxy file system comprises at least one module to facilitate at least one of the following functions: security, locking, file sharing, and change notifications.

7. The system of claim 1, wherein the proxy file system is smaller in size than the shared storage.

8. The system of claim 1, wherein the controller comprises a server.

9. The system of claim 1, wherein the controller comprises:
an allocator module for allocating and de-allocating portions of the shared storage to the counterpart data files; and
a network interface module for facilitating communications with the plurality of clients.

10. The system of claim 9, wherein the allocator module comprises program code for managing a plurality of allocation units.

11. The system of claim 10, wherein the allocation units indicate locations of portions of the shared storage allocated to information in the counterpart data files.

12. The system of claim 1, wherein the information for accessing the counterpart data files comprises information indicating locations of the counterpart files on the shared storage.

13. The system of claim 1, wherein the plurality of clients include software for communicating with the controller and the shared storage.

14. The system of claim 1, further comprising a secondary controller configured to mirror the controller and replace the controller if the controller is disabled.

15. The system of claim 14, further comprising a secondary proxy file system coupled to the secondary controller.

16. A file management method, comprising:
managing a plurality of proxy files, wherein the plurality of proxy files are associated with counterpart data files in a shared storage and include information for accessing the counterpart data files from the shared storage; and
controlling access by a plurality of clients to the counterpart data files in the shared storage via the proxy files.

17. The method of claim 16, wherein controlling access comprises providing the clients with access to the counterpart data files in the shared storage using the access information included in the proxy files.

18. The system of claim 17, wherein providing the clients with access to the counterpart data files comprises providing the clients with information indicating locations of the counterpart files on the shared storage.

19. The method of claim 16, wherein controlling access to the counterpart data files comprises:
recognizing attempts by the clients to access the counterpart data files in the shared storage;
retrieving from the proxy files the information for accessing the counterpart data files from the shared storage in response to the access attempts; and
providing the clients with access to the counterpart data files in the shared storage using the information retrieved from the proxy files.

20. In a system having a controller serving clients and a shared storage controlling data files, a method for managing information, comprising:
recognizing by the controller an attempt by a client to access a data file in the shared storage;
accessing a proxy file corresponding to the data file in response to the access attempt;
retrieving from the proxy file information for accessing the data file from the shared storage; and
providing the client with access to the data file in the shared storage using the retrieved access information.

21. The method of claim 20, wherein recognizing the attempt to access a data file comprises receiving by the controller a request to access the data file.

22. The method of claim 20, wherein accessing a proxy file comprises accessing the proxy file from a local disk coupled to the controller.

23. The method of claim 20, wherein retrieving information for accessing comprises reading from the proxy file information indicating a location of the data file in the shared storage.

24. The method of claim 20, wherein providing access to the data file comprises providing the client with information indicating a location of the data file in the shared storage.

25. The method of claim 20, wherein providing access to the data file comprises providing the client with information indicating a manner in which to open the data file in the shared storage.

26. A method of reading information from a data file in a shared storage, comprising:
receiving by a controller a request from a client to read from the data file in the shared storage;
obtaining by the controller information for reading the data file from a proxy file corresponding to the data file in response to the request; and
providing the information obtained from the proxy file to the client, wherein the information from the proxy file enables the client to read the data file from the shared storage.

27. The method of claim 26, wherein obtaining information for reading the data file includes obtaining a location of a portion of the shared storage allocated to the data file.

28. The method of claim 26, wherein obtaining information for reading the data file includes obtaining information indicating a manner in which to read the data file from the shared storage.

29. The method of claim 26, wherein receiving a request from a client includes receiving the request over a network interposed between the client and the controller.

30. The method of claim 26, wherein obtaining information for reading the data file includes obtaining the information for reading the data file in the shared storage from a proxy file corresponding to the data file located in a storage directly coupled to the controller.

31. A method of writing information to a data file in a shared storage, comprising:
receiving by a controller a request from a client to write information to a data file in the shared storage;
acquiring by the controller an available portion of the shared storage in response to the request; and
inserting information identifying the acquired portion of the shared storage into a proxy file corresponding to the data file, wherein the proxy file is located on a storage directly coupled to the controller.

32. The method of claim 31, wherein receiving a request from a client comprises receiving the request over a network interposed between the client and the controller.

33. The method of claim 31, wherein acquiring the available portion of the shared storage comprises identifying the available portion.

34. The method of claim 33, wherein identifying the available portion comprises examining a list of allocation unit numbers.

35. The method of claim 31, further comprising allocating the acquired portion of the shared storage to the data file.

36. The method of claim 31, wherein inserting information comprises writing allocation unit numbers into the proxy file.

37. The method of claim 31, further comprising managing the proxy file by a non-sharable proxy file system.

38. The method of claim 37, wherein managing the proxy file comprises managing the proxy file by a non-sharable proxy file system running on a local disk directly coupled to the controller.

39. A file management system, comprising:
means for storing a plurality data files, the storing means accessible to a plurality of clients;
means for managing a plurality of proxy files, wherein each of the plurality of proxy files is associated with a counterpart data file from among the plurality of data files in the storing means and includes information for accessing the counterpart data file; and
means for controlling access by the plurality of clients to the plurality of data files using the managing means.

40. The system of claim 39, further comprising secondary controlling means for replacing the controlling means if the controlling means is disabled.

41. The system of claim 40, further comprising secondary managing means, for managing the plurality of proxy files, coupled to the secondary controlling means.

42. A computer-readable medium containing instructions for controlling a computer system coupled to a network to perform a method, the computer system having a processor for executing the instructions, the method comprising:
recognizing an attempt by a client to access a data file in a shared storage;
accessing a proxy file corresponding to the data file in response to the access attempt;
retrieving from the proxy file information for accessing the data file in the shared storage; and
providing the client with access to the data file in the shared storage using the retrieved access information.
